(19) United States
(12) Patent Application Publication
(10) Pub. No.: US 2011/0019742 A1
(43) Pub. Date: Jan. 27, 2011

(54) COMPRESSION ARTIFACT REMOVING APPARATUS AND VIDEO REPRODUCING APPARATUS

(75) Inventor: Shen Li, Kawasaki-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/727,494

(22) Filed: Mar. 19, 2010

(30) Foreign Application Priority Data
Jul. 27, 2009 (JP) 2009-174269

(51) Int. Cl. H04N 7/26; H04N 7/12

(52) U.S. Cl. 375/240.16; 375/E07.076; 375/E07.027; 386/E05.003; 386/353

(57) ABSTRACT

A compression artifact removing apparatus according to the present invention performs a filtering process on the target pixel, using the same filter as used for the best match pixel in the reference frame, when a scene change has not occurred in the target frame and a temporal correlation of the local area around the target pixel and the local area around its best match is high, to reduce the amount of computation.

### CROSS REFERENCE TO RELATED APPLICATION

This application is based upon and claims benefit of priority from the Japanese Patent Application No. 2009-174269, filed on Jul. 27, 2009, the entire contents of which are incorporated herein by reference.

### BACKGROUND OF THE INVENTION

1. Field of the Invention

The present invention relates to a compression artifact removing apparatus and a video reproducing apparatus.

2. Related Art

In a typical video encoding process, an image frame is generally divided into square shaped blocks composed of n×m pixels (n and m are arbitrary integers), and for each block orthogonal transform, such as discrete cosign transform (DCT), and quantization are executed. As a consequence of this kind of encoding scheme, compression artifacts such as block artifact or mosquito noise will appear in block boundary areas of decoded images.

In order to remove the compression artifacts, edge adaptive filtering techniques that select optimal filters based on the direction and the strength of local edges have been proposed (for example, Japanese Patent Application Laid-Open Nos. 2003-259367 and 2004-282442).

However, since edge-adaptive filtering techniques usually adopt pixel-based local edge detection, which requires huge amount of computation, they are not suitable for portable terminals where the processing capability and the battery capacity are limited.

### SUMMARY OF THE INVENTION

According to one aspect of the present invention, there is provided a compression artifact removing apparatus that performs filtering on each of a plurality of frames included in input video data, using one of a plurality of filters stored in a storage unit, the apparatus comprising:

a correlation degree determiner that calculates the motion prediction error between a first local area which is around a target pixel in a target frame where scene change has not occurred and a second local area which is around a best match pixel in a reference frame whose location is decided with a position of the target pixel and an inter-frame motion vector, and determines the temporal correlation degree as low when the motion prediction error exceeds a predetermined threshold value, and determines the temporal correlation degree as high when the motion prediction error is less than or equal to the predetermined threshold value,

a filter selector that either performs edge detection for the target pixel and then selects one filter from the plurality of filters based on a direction and a strength of the detected edge when scene change has occurred in the target frame or the temporal correlation is determined as low, or selects the same filter as applied to the best match pixel when the temporal correlation degree is determined as high; and

a filter processor that performs filtering on the target pixel, using the filter selected by the filter selector.

According to one aspect of the present invention, there is provided a compression artifact removing apparatus that performs filtering on each of a plurality of frames included in an input video signal, using one of a plurality of filters stored in a storage unit, the apparatus comprising:

a correlation degree determiner that calculates the variation in motion vectors corresponding to a local area around a target pixel in a filtering target frame where a scene change is not detected, and determines the temporal correlation degree as low when the variation exceeds a predetermined threshold value, and determines the temporal correlation degree as high when the variation is less than or equal to the predetermined threshold value;

a filter selector that performs edge detection for the target pixel and selects one of the filters based on a direction and a strength of the detected edge when a scene change is detected in the filtering target frame or the temporal correlation degree is determined as low, or selects the same filter as the one applied to a best match pixel in a reference frame decided by a position of the target pixel and a corresponding inter-frame motion vector, when the temporal correlation degree is determined as high; and

a filter processor that performs filtering on the target pixel, using the filter selected by the filter selector.

According to one aspect of the present invention, there is provided a video reproducing apparatus, comprising:

a decoder that decodes an input video signal including a plurality of frames and extracts information on inter-frame motion vectors;

a storage unit that stores a plurality of filters;

a compression artifact removing apparatus that includes a correlation degree determiner that calculates the motion prediction error between a first local area which is around a target pixel in a target frame where scene change has not occurred and a second local area which is around a best match pixel in a reference frame whose location is decided with a position of the target pixel and an inter-frame motion vector, and determines the temporal correlation degree as low when the motion prediction error exceeds a predetermined threshold value, and determines the temporal correlation degree as high when the motion prediction error is less than or equal to the predetermined threshold value, a filter selector that either performs edge detection for the target pixel and then selects one filter from a plurality of filters based on a direction and a strength of the detected edge when scene change has occurred in the target frame or the temporal correlation is determined as low, or selects the same filter as applied to the best match pixel when the temporal correlation degree is determined as high, and a filter processor that performs filtering on the target pixel, using the filter selected by the filter selector; and

a controller that continuously displays image data, which are generated by the filtering process, on an image display unit.

### BRIEF DESCRIPTION OF THE DRAWINGS

FIG. 1 is a schematic diagram illustrating a video reproducing apparatus according to the first embodiment of the present invention;

FIG. 2 is a diagram illustrating an example of predictors;

FIG. 3 is a diagram illustrating an example of a best match pixel;

FIG. 4 is a flowchart illustrating the compression artifact removing method according to the first embodiment;

FIG. 5 is a schematic diagram illustrating a video reproducing apparatus according to the second embodiment of the present invention; and

FIG. 6 is a flowchart illustrating the compression artifact removing method according to the second embodiment.

### DETAILED DESCRIPTION OF THE INVENTION

Hereafter, embodiments of the present invention will be described with reference to the drawings.

### First Embodiment

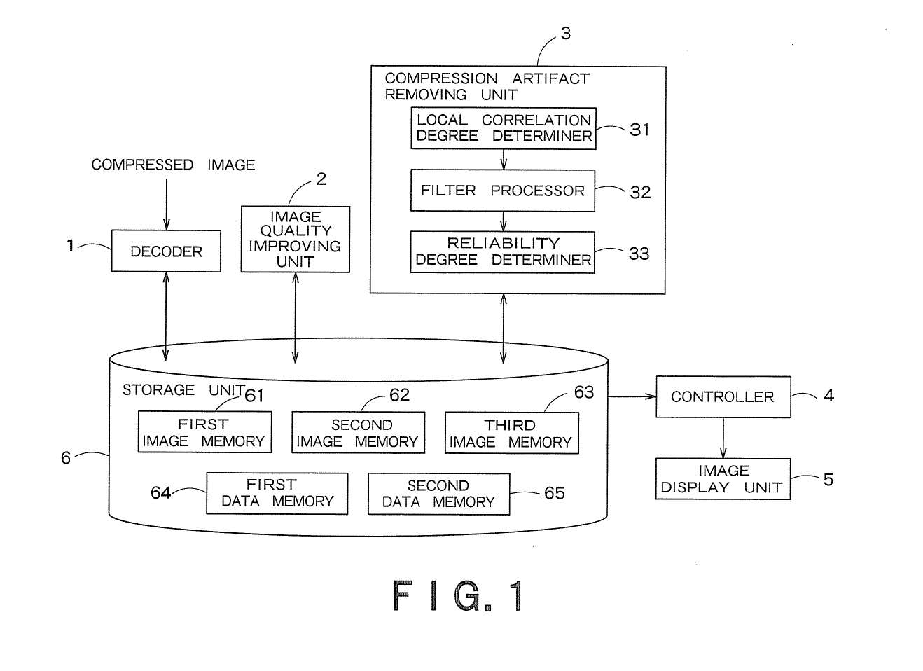

FIG. 1 illustrates the schematic of a video reproducing apparatus according to the first embodiment of the present invention. The video reproducing apparatus includes a decoder 1, an image quality improving unit 2, a compression artifact removing unit 3, a controller 4, an image display unit 5, and a storage unit 6. The compression artifact removing unit 3 has a local correlation degree determiner 31, a filter selector 32, and a filter processor 33. The storage unit 6 has a first image memory 61, a second image memory 62, a third image memory 63, a first data memory 64, and a second data memory 65.

The decoder 1 decodes encoded video data and stores the decoded data in the first image memory 61. The encoded video data conform to video coding standards, such as MPEG-1, MPEG-2, MPEG-4, and H.264/AVC.

The decoder 1 is equipped with functions for extracting features of images. For example, the decoder 1 extracts information on motion vectors (MV) in P frames and a B frames. In this case, a P frame is a frame that is encoded by inter-frame prediction, referring to a temporally previous frame (for example, immediately previous frame). The B frame is a frame that is encoded by inter-frame prediction, referring to a temporally previous frame, or a temporally subsequent frame, or both the previous and subsequent frames.

The decoder 1 extracts the index number of an I frame. The I frame is a frame that is compressed and re-constructed by using intra-frame information only, and is inserted into the compressed video at a constant interval.

The decoder 1 detects scene changes and extracts the index number of the frame where a scene change is detected. For example, when a frame is not the P/B frame, the decoder 1 determines that a scene change has occurred.

The decoder 1 detects local edges. The decoder 1 stores the detected MV information, the extracted index numbers of I frames, the index number of the frame(s) where scene changes are detected, and other side information, such as edge information, in the first data memory 64.

The image quality improving unit 2 extracts the decoded data from the first image memory 61, performs an image quality improving process, and stores the data after the process in the second image memory 62. The image quality improving processes may include, for example, contour enhancement, smoothing, frame re-sizing, and frame insertion for smooth motion. The image quality improving unit 2 can use a switch to turn ON/OFF these operations.

The local correlation degree determiner 31 of the compression artifact removing unit 3 refers to the side information that is stored in the first data memory 64, and detects whether scene change has occurred in the target frame for compression artifact removing process. When a scene change is detected, the local correlation degree determiner 31 will notify the filter selector 32 of the successful detection of scene change.

When the scene change is not detected in the target frame, the local correlation degree determiner 31 determines whether the temporal correlation of a local area of the target frame is high. Two methods for determining the temporal correlation of a local area will be described in detail below.

In the first method, first, an area of N×N pixels (N is an integer of 2 or more) around the target pixel is defined as area A. According to a position of the target pixel, 1 to 4 macro block (for example, blocks of 16×16 pixels) motion vectors will be available. For the rest of the document, the motion vectors mentioned above will be referred to as predictors.

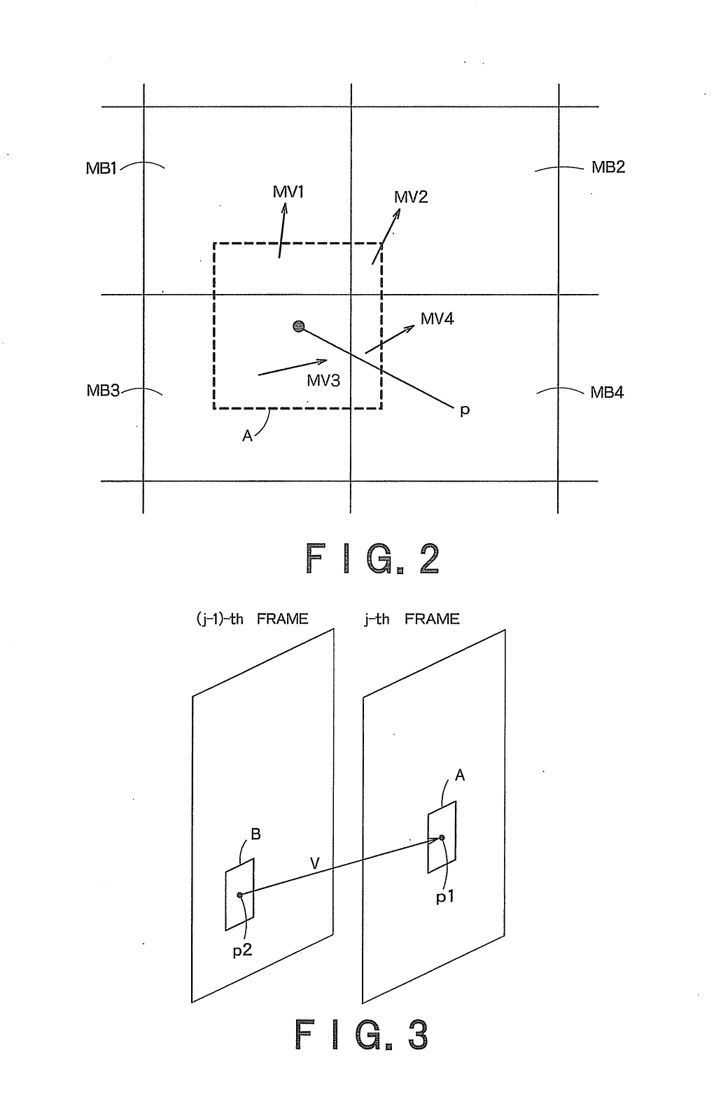

For example, as illustrated in FIG. 2, as the area A around the target pixel p overlaps four macro blocks MB1 to MB4, four predictors MV1 to MV4 are available for reference.

Next, a predicted motion vector is generated with the median value of the predictors. Each predictor may be weighted according to the size of the area where the corresponding macro block overlaps the area A.

Next, an area of N×N pixels around a pixel (best match pixel) in the reference frame whose position is decided by the predicted motion vector is defined as area B. For example, as illustrated in FIG. 3, the best match pixel p2 in the (j−1)-th frame (reference frame) is decided according to the position of the target pixel p1 in the j-th (j is an integer of 2 or more) frame (frame to be processed) and a predicted motion vector V, and the area around the best match pixel p2 is defined as area B.

Next, the motion prediction error of the area A and area B is calculated. As a quantitative criterion of motion prediction error, for example, sum of absolute difference (SAD) or mean square error (MSE) is calculated. When the calculated value exceeds a predetermined threshold value, the temporal correlation is determined as “low”. For the rest of the document, low temporal correlation is an equivalent of local scene change. Meanwhile, when the calculation result is the threshold value or less, the temporal correlation is “high” and the local scene change will not be considered occurred.

Next, the second method will be introduced. First, similar to the first method described above, an area A is defined and the predictors are calculated.

Next, a variation in the predictors is calculated. As a quantitative criterion, variance is used. In the calculation of the variance, each predictor may be weighted according to the size of the area where the corresponding macro block overlaps the area A.

When the variance in the predictors exceeds the predetermined threshold value, local scene change is considered to have occurred.

The local correlation degree determiner 31 notifies the filter selector 32 of whether local scene changes have occurred.

The filter selector 32 selects a most appropriate filter for the target pixel from a plurality of filters stored in the second data memory 65, based on the result received from the local correlation degree determiner 31.

When scene change is detected in the target frame or the local scene change is detected in the local area around the target pixel, the filter selector 33 selects an optimal filter for the target pixel, which is similar to the edge adaptive filtering techniques mentioned in the related art. That is to say, the filter selector 32 detects local edge(s) at the position of the target pixel, and selects the optimal filter for the target pixel among a plurality of filters stored in the second data memory 65, based on the direction and the strength of the edge.

When neither a scene change in the target frame nor a local scene change in the local area around the target pixel is detected, the filter selector 32 selects the filter that is applied to the best match pixel p2 in the reference frame (for example, (j−1)-th frame), which corresponds to the target pixel p1 in the target frame (j-th frame). Since the edge detection of the target pixel does not need to be performed, the computation can be reduced, as compared with the case where the scene change or the local scene change is generated.

The filter processor 33 uses the filter selected by the filter selector 32 to perform filtering (convolution operation) on the target pixel, to remove the compression artifacts. The filtered image data is stored in the third image memory 63.

The compression artifact removing unit 3 may take the output of the image quality improving process as input image data from the second image memory 62, for compression artifact removing. The image quality improving unit 2 may take the output of the compression artifact removing as input image data from the third image memory 63, and perform the image quality improving process.

The controller 4 obtains the image data stored in the second image memory 62 or the third image memory 63 and continuously displays the image data on the image display unit 5.

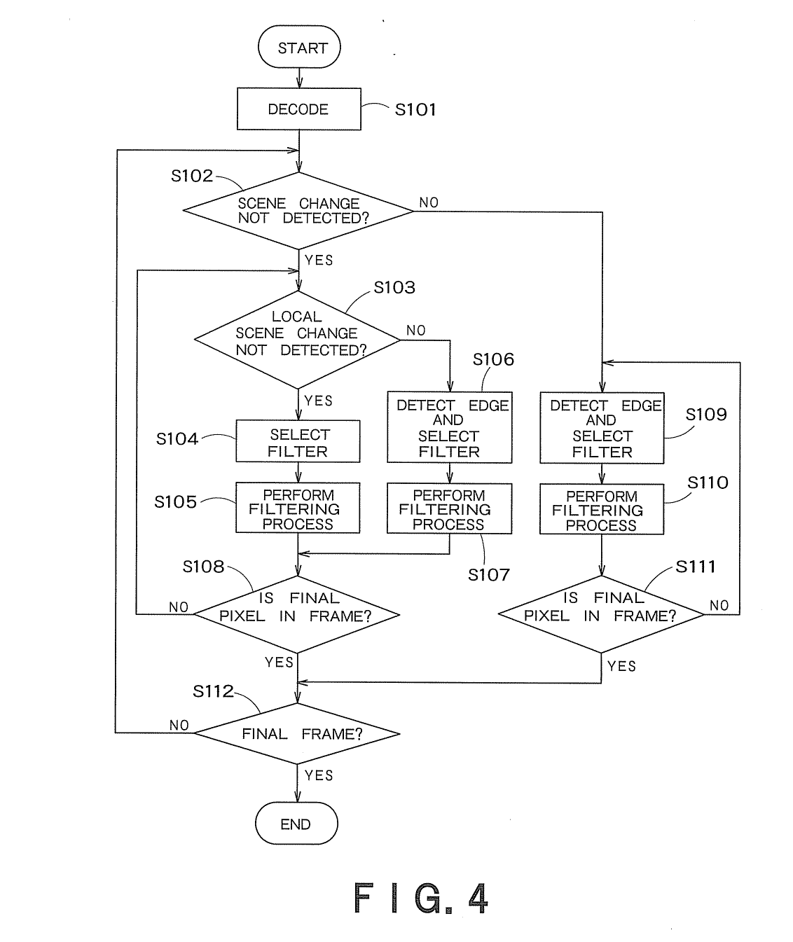

In FIG. 4 a flow chart shows how the compressed video data that is executed by the video reproducing apparatus.

(Step S101) The decoder 1 decodes the compressed and encoded video data. The decoder 1 performs scene change detection for each frame, and stores side information including the detection results in the first data memory 64.

(Step S102) The local correlation degree determiner 31 of the compression artifact removing unit 3 refers to the side information that is stored in the first data memory 64, and finds out whether scene change is detected in the target frame. The procedure proceeds to step S103 when the scene change detection result is negative. Otherwise, the procedure proceeds to step S109.

(Step S103) The local correlation degree determiner 31 uses the side information that is stored in the first data memory 64, and decides whether the local scene change has occurred in the local area around the target pixel p1, by using the first method described above. When the local scene change is detected, the procedure proceeds to step S104. Otherwise, the procedure proceeds to step S106.

(Step S104) The filter selector 32 selects the filter applied to the best match pixel in the reference frame, which corresponds to the target pixel.

(Step S105). The filter processor 33 filters the target pixel using the filter that is selected in step S104.

(Step S106) The filter selector 32 performs edge detection for the target pixel, and selects the optimal filter for the target pixel, from a plurality of filters that are stored in the second data memory 65, based on the direction and the strength of the edge.

(Step S107) The filter processor 33 filters the target pixel using the filter that is selected in step S106.

(Step S108) A check is performed to determine whether the target pixel is the last pixel in the target frame. When the filtered target pixel is the final pixel in the target frame, the procedure proceeds to step S112. Otherwise when the filtered target pixel is not the final pixel, the procedure returns to step S103, where local scene change detection is performed for the next target pixel.

(Step S109) The filter selector 32 detects the edge at the position of the target pixel, and selects the optimal filter for target pixel, from a plurality of filters that are stored in the second data memory 65, based on the direction and the strength of the edge.

(Step S110) The filter processor 33 filters the target pixel using the filter that is selected in step S109.

(Step S111) A check is performed to determine whether the target pixel is the last pixel in the target frame. When the filtered target pixel is the final pixel in the target frame, the procedure proceeds to step S112. Otherwise when the filtered target pixel is not the final pixel, the procedure returns to step S109, where local scene change detection is performed for the next target pixel.

(Step S112) A check is performed to determine whether the target frame is the final frame to process. When it is the final frame, the process will end. When it is not the final frame, the procedure returns to step S102, where scene change detection is performed for the next target frame.

As described above, in the present embodiment, the filter applied to the corresponding pixel (best match pixel) in the reference frame will be reselected for processing the target pixel, if high temporal correlation is detected for the local area where the target pixel is located and scene change has not occurred in the target frame. Since the edge detection becomes unnecessary the computation amount required to remove the compression artifact can be reduced.

### Second Embodiment

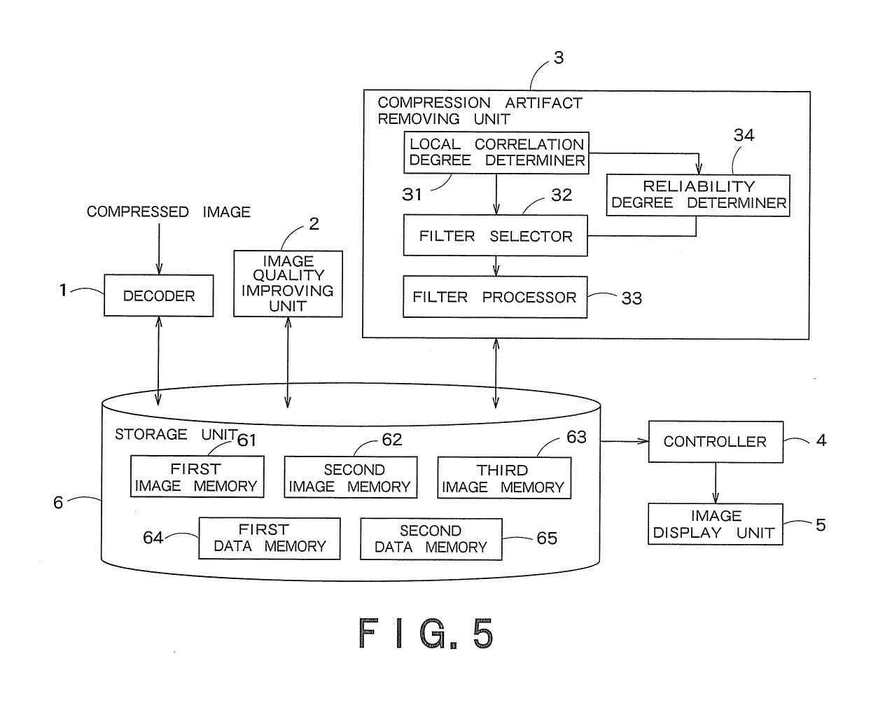

FIG. 5 illustrates the schematic of a video reproducing apparatus according to the second embodiment of the present invention. The present embodiment has the same schematic as that of the first embodiment illustrated in FIG. 1, except that a reliability degree determiner 34 is further provided in the compression artifact removing unit 3. In FIG. 5, the same components as those of the first embodiment illustrated in FIG. 1 are denoted by the same reference numbers, for which detailed descriptions will not omitted.

When local scene change is not detected in the local area around the target pixel, for all the local areas corresponding to the pixels in the neighborhood (for example, area A of FIG. 3) of the target pixel, the reliability degree determiner 34 counts the number of the areas where local scene change is not detected. When the count value is smaller than a predetermined value 6, this indicates that probably the local scene changes could not be accurately detected for the target pixel. Therefore, the reliability degree determiner 34 determines the reliability degree of the result of the local correlation degree determiner 31 as “low”, and notifies the filter selector 32 of the determination result.

If the filter selector 32 receives from the reliability degree determiner 34 a result indicating that the reliability degree of the result of the local correlation degree determiner 31 is low, even if neither a scene change in the target frame nor a local scene change in the local area around the target pixel has been detected, the filter selector 32 performs edge detection for the target pixel, and selects the optimal filter for it, from a plurality of filters stored in the second data memory 65, based on the direction and the strength of the edge.

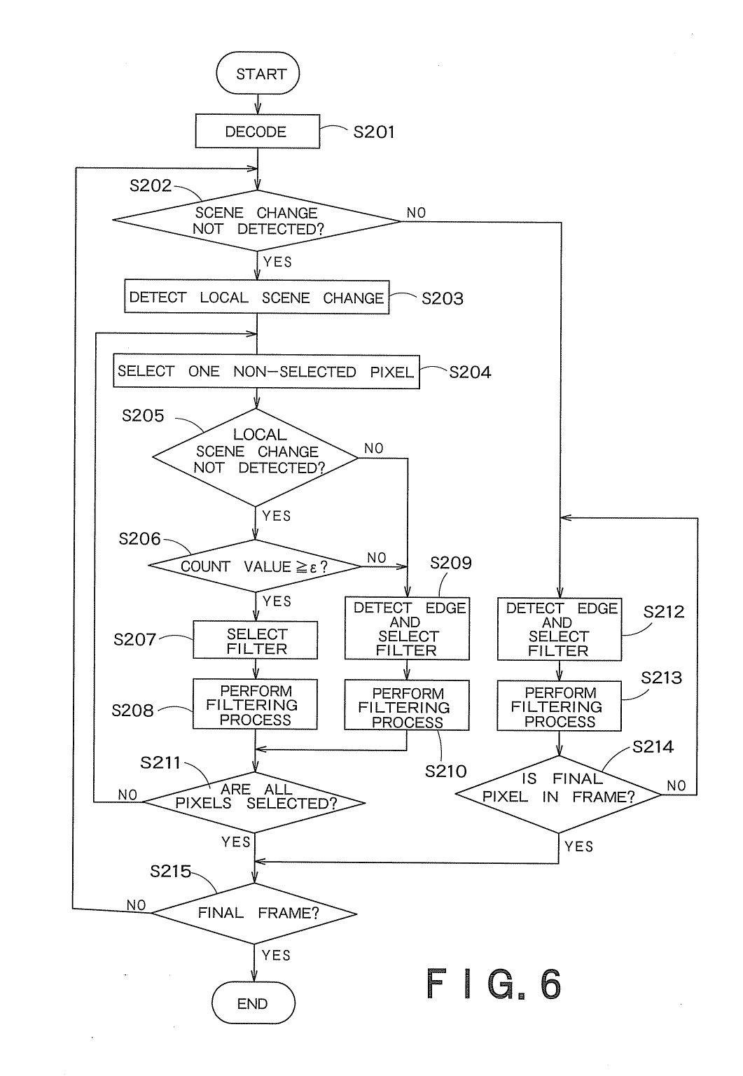

In FIG. 6 a flow chart shows how the compressed video data that is executed by the video reproducing apparatus.

(Step S201) The decoder 1 decodes the compressed and encoded video data. The decoder 1 performs scene change detection for each frame, and stores side information including the detection results in the first data memory 64.

(Step S202) The local correlation degree determiner 31 refers to the side information that is stored in the first data memory 64, and finds out whether scene change is detected in the target frame. The procedure proceeds to step S203 when the scene change detection result is negative. Otherwise, the procedure proceeds to step S212.

(Step S203) For each pixel in the target frame, in the local area corresponding to the pixel, local scene change detection is performed. The results are stored in the first data memory 64.

(Step S204) A pixel which is not yet processed is selected from the target frame as the target pixel.

(Step S205). The local correlation degree determiner 31 refers to the detection results stored in the first data memory 64, and finds out whether local scene change is detected in the local area around the target pixel selected in step S204. When a local scene change is detected, the procedure proceeds to step S209. Otherwise, the procedure proceeds to step S206.

(Step S206) The reliability degree determiner 34 refers to the detection results stored in the first data memory 64. For all the local areas corresponding to the pixels in the neighborhood (for example, area A of FIG. 3) of the target pixel, the reliability degree determiner 34 counts the number of the areas where local scene change is not detected. When the count value is no less than the predetermined value 6 or more, the procedure proceeds to step S207. Otherwise, the procedure proceeds to step S209.

(Step S207) The filter selector 32 selects the filter applied to the best match pixel in the reference frame (previous frame of the target frame), which corresponds to the target pixel.

(Step S208) The filter processor 33 filters the target pixel using the filter selected in step S207.

(Step S209) The filter selector 32 detects the edge at the position of the target pixel, and selects the optimal filter for target pixel, from a plurality of filters that are stored in the second data memory 65, based on the direction and the strength of the edge.

(Step S210) The filter processor 33 filters the target pixel using the filter that is selected in step S209.

(Step S211) When all the pixels in the target frame have been selected, the procedure proceeds to step S215. Otherwise, the procedure returns to step S204.

(Step S212) The filter selector 32 detects the edge at the position of the target pixel, and selects the optimal filter for target pixel, from a plurality of filters that are stored in the second data memory 65, based on the direction and the strength of the edge.

(Step S213) The filter processor 33 filters the target pixel using the filter that is selected in step S212.

(Step S214) A check is performed to determine whether the target pixel is the final pixel in the target frame. When the filtered target pixel is the final pixel in the target frame, the procedure proceeds to step S215. Otherwise when the filtered target pixel is not the final pixel, the procedure returns to step S212, where edge detection is performed for the next target pixel.

(Step S215) A check is performed to determine whether the target frame is the final frame to process. When it is the final frame, the process will come to an end. When it is not the final frame, the procedure returns to step S202, where scene change detection is performed for the next target frame.

As described above, in the present embodiment, the reliability degree (accuracy) of the local scene change detection results is determined. When the reliability degree is “low”, the filter used in the previous frames will not be used again, and the edge detection and the selection of the optimal filter are performed. Therefore, as compared with the first embodiment, the operation amount may increase, but the image quality of the reproduced video can be better guaranteed.

In the above embodiments, with respect to the pixels where neither local scene change in the local area nor scene change in the target frame is detected, the filter applied to the corresponding pixel (best match pixel) in the previous frame is reused. However, the reuse not only means that the previously used filter is used as it is, but also means the use of a filter with adjustments made based on the features of the images of a small area (area A) around the target pixel and a small area (area B) around the best match pixel.

In the above embodiments, the edge detection and the filter selection are performed pixel by pixel, but may be also performed on macro block level.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A compression artifact removing apparatus that performs filtering on each of a plurality of frames included in input video data, using one of a plurality of filters stored in a storage unit, the apparatus comprising:
a correlation degree determiner that calculates the motion prediction error between a first local area which is around a target pixel in a target frame where scene change has not occurred and a second local area which is around a best match pixel in a reference frame whose location is decided with a position of the target pixel and an inter-frame motion vector, determines the temporal correlation degree as low when the motion prediction error exceeds a predetermined threshold value, and determines the temporal correlation degree as high when the motion prediction error is less than or equal to the predetermined threshold value,
a filter selector that either performs edge detection for the target pixel and then selects one filter from the plurality of filters based on a direction and a strength of the detected edge when scene change has occurred in the target frame or the temporal correlation is determined as low, or selects the same filter as applied to the best match pixel when the temporal correlation degree is determined as high; and
a filter processor that performs filtering on the target pixel, using the filter selected by the filter selector.

2. The compression artifact removing apparatus according to claim 1, further comprising:
a reliability degree determiner that counts a number of pixels for which the temporal correlation degree is determined as high in a neighborhood of the target pixel whose temporal correlation degree is determined as high, and notifies the filter selector of a count value when the count value is less than a predetermined value,
wherein, when the filter selector receives the notification, the filter selector performs edge detection for the target pixel, and selects one out of the candidate filters based on the direction and the strength of the detected edge.

3. The compression artifact removing apparatus according to claim 1,
wherein a decoder that decodes the input video signal is used to detect scene change in the target frame, and
the correlation degree determiner and the filter selector refer to the detection results provided by the decoder.

4. The compression artifact removing apparatus according to claim 1,
wherein a decoder that decodes the input video signal is used to extract information on the motion vectors included in the input video signal, and
the correlation degree determiner refers to information on the motion vectors extracted by the decoder.

5. A compression artifact removing apparatus that performs filtering on each of a plurality of frames included in an input video signal, using one of a plurality of filters stored in a storage unit, the apparatus comprising:
a correlation degree determiner that calculates the variation in motion vectors corresponding to a local area around a target pixel in a filtering target frame where a scene change is not detected, and determines the temporal correlation degree as low when the variation exceeds a predetermined threshold value, and determines the temporal correlation degree as high when the variation is less than or equal to the predetermined threshold value;
a filter selector that performs edge detection for the target pixel and selects one of the filters based on a direction and a strength of the detected edge when a scene change is detected in the filtering target frame or the temporal correlation degree is determined as low, or selects the same filter as the one applied to a best match pixel in a reference frame decided by a position of the target pixel and a corresponding inter-frame motion vector, when the temporal correlation degree is determined as high; and
a filter processor that performs filtering on the target pixel, using the filter selected by the filter selector.

6. The compression artifact removing apparatus according to claim 5, further comprising:
a reliability degree determiner that counts a number of pixels for which the temporal correlation degree is determined as high in a neighborhood of the target pixel, if the temporal correlation degree is determined as high for the target pixel, and notifies the filter selector of a count value when the count value is less than a predetermined value,
wherein, when the filter selector receives the notification, the filter selector performs edge detection for the target pixel, and selects one out of the candidate filters based on the direction and the strength of the detected edge.

7. The compression artifact removing apparatus according to claim 5
wherein a decoder that decodes the input video signal is used to detect scene change in the target frame, and
the correlation degree determiner and the filter selector refer to the detection results provided by the decoder.

8. The compression artifact removing apparatus according to claim 5,
wherein a decoder that decodes the input video signal is used to extract information on the motion vectors included in the input video signal, and
the correlation degree determiner refers to information on the motion vectors extracted by the decoder.

9. A video reproducing apparatus, comprising:
a decoder that decodes an input video signal including a plurality of frames and extracts information on inter-frame motion vectors;
a storage unit that stores a plurality of filters;
a compression artifact removing apparatus that includes a correlation degree determiner that calculates the motion prediction error between a first local area which is around a target pixel in a target frame where scene change has not occurred and a second local area which is around a best match pixel in a reference frame whose location is decided with a position of the target pixel and an inter-frame motion vector, and determines the temporal correlation degree as low when the motion prediction error exceeds a predetermined threshold value, and determines the temporal correlation degree as high when the motion prediction error is less than or equal to the predetermined threshold value, a filter selector that either performs edge detection for the target pixel and then selects one filter from a plurality of filters based on a direction and a strength of the detected edge when scene change has occurred in the target frame or the temporal correlation is determined as low, or selects the same filter as applied to the best match pixel when the temporal correlation degree is determined as high, and a filter processor that performs filtering on the target pixel, using the filter selected by the filter selector; and
a controller that continuously displays image data, which are generated by the filtering process, on an image display unit.

10. The video reproducing apparatus according to claim 9, further comprising:
an image quality improving unit that performs an image quality improving process on the image data.

11. The video reproducing apparatus according to claim 9, further comprising:
a reliability degree determiner that counts a number of pixels for which the temporal correlation degree is determined as high in a neighborhood of the target pixel, if the temporal correlation degree is determined as high for the target pixel, and notifies the filter selector of a count value when the it is less than a predetermined value,
wherein, when the filter selector receives the notification, the filter selector performs edge detection for the target pixel, and selects one out of the candidate filters based on the direction and the strength of the detected edge.

12. The video reproducing apparatus according to claim 9,
wherein the decoder detects scene changes in the target frame, and
the correlation degree determiner and the filter selector refer to the detection results provided by the decoder.
